(19) United States
(12) Patent Application Publication
(10) Pub. No.: US 2025/0301328 A1
(43) Pub. Date: Sep. 25, 2025

(54) DISTRIBUTED ANOMALY DETECTION AND LOCALIZATION FOR CYBER-PHYSICAL SYSTEMS

(71) Applicant: GENERAL ELECTRIC COMPANY, Schenectady, NY (US)

(72) Inventors: Masoud ABBASZADEH, Clifton Park, NY (US); Matthew NIELSEN, Schenectady, NY (US); Stephen F. BUSH, Latham, NY (US)

(21) Appl. No.: 18/868,830

(22) PCT Filed: May 22, 2023
(86) PCT No.: PCT/US2023/067283

§ 371 Date: Nov. 25, 2024

Related U.S. Application Data
(60) Provisional application No. 63/344,711, filed on May 23, 2022.

(51) Int. Cl. H04W 12/122

(52) U.S. Cl. CPC H04W 12/122

(57) ABSTRACT

A system to protect an industrial asset includes a plurality of monitoring nodes each generating a data stream of current monitoring node values in time-domain, and a virtual agent associated with each of the plurality of monitoring nodes. the virtual agent being configured to detect anomalous performance of the corresponding monitoring node and configured to communicate with one or more other virtual agents via a network.

### CROSS-REFERENCE TO RELATED APPLICATIONS

This application claims the benefit of priority to U.S. Provisional Patent Application No. 63/344,711, filed on May 23, 2022, which is incorporated herein by reference in its entirety.

### TECHNICAL FIELD

The present description relates generally to security and resilience of cyber-physical systems, and, more particularly to distributed and partially distributed systems and methods for anomaly detection and localization in cyber-physical systems and devices connected through an internet of things (IoT) network (such as 5G wireless network).

### BACKGROUND

Industrial networks are composed of specialized components and applications such as, for example, programmable logic controllers (PLCs), SCADA systems, and DCS. There are other components of industrial cyber-physical systems (ICS) such as remote terminal unit (RTU), intelligent electronic devices (IED), and phasor measurement units (PMU). Those devices communicate with the human-machine interface (HMI) located in the control network. With the rise of 5G and industrial IoT, the ICS architecture is becoming even more connected with lower-level edge devices increasingly connected to each other and to the cloud. Consequently, the attack surface for cyberattacks has expanded, thereby requiring better cybersecurity solutions.

Increased connectivity and reduced latency have also enabled design of distributed architectures and distributed edge computing, creating both cybersecurity opportunities and challenges.

Cyberattack detection is in general concerned with detecting a malicious cyber incident in a system. On the other hand, cyberattack isolation is concerned with pinpointing specific part(s) of the system that are under attack and trying to trace back the entry point(s), and the root cause of the cyberattack. Localizing the initial point(s) of cyber incident is both important and difficult, considering that an attack may cause a series of cascaded events or propagate through the system, especially in feedback control systems.

### BRIEF DESCRIPTION OF THE DRAWINGS

Certain features of the subject technology are set forth in the appended claims. However, for purpose of explanation, several aspects of the subject technology are set forth in the following figures.

FIG. 1 shows a centralized architecture for attack detection and localization using a single digital ghost agent sitting in the cloud monitoring a collection of edge devices.

FIG. 2 shows a partially distributed anomaly detection and/or localization architecture in accordance with an embodiment of the present disclosure.

FIG. 3 shows a fully distributed anomaly detection and/or localization architecture in accordance with an embodiment of the present disclosure.

FIG. 3A depicts an example in which the digital ghost agent is physically separated from its corresponding edge device, in accordance with some embodiments of the present disclosure.

FIG. 4 shows how information relating to performance, monitoring, detection and/or localization may be shared among digital ghost agents in accordance with the embodiments of the present disclosure.

FIG. 5 illustrates an anomaly detection and mitigation system with components connected over a wireless network, in accordance with at least some embodiments of the present disclosure.

FIG. 6 illustrates an anomaly detection system 300 in accordance with at least some embodiments of the present disclosure.

FIG. 7 illustrates an example of the anomaly detection model in accordance with at least some embodiments of the present disclosure.

FIG. 8 illustrates a method of generating current system function parameters that may be performed by the current system function processor described herein, in accordance with at least some embodiments of the present disclosure.

FIG. 9 illustrates a method for calculating a decision boundary, according to at least some embodiments of the present disclosure.

FIG. 10 illustrates an off-line process for generating decision boundary, in accordance with at least some embodiments of the present disclosure.

FIG. 11 illustrates a real-time process for protecting an industrial asset, in accordance with at least some embodiments of the present disclosure.

FIG. 12 is a synthetic attack injection method, in accordance with at least some embodiments of the present disclosure.

FIG. 13 illustrates an off-line training process in accordance with at least some embodiments of the present disclosure.

FIG. 14 illustrates an electronic system with which one or more embodiments of present disclosure may be implemented.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

As noted above, industrial control systems that operate physical systems are increasingly connected to a network, such as, an internet of things (IoT) network, a communication network compatible with a 3rd Generation Partnership Project (3GPP) standard, such as a fifth-generation (5G) or sixth-generation (6G) wireless communication system or network, or a network or system defined per the IEEE 802.1 standard. The term “industrial,” as used herein, may be associated with any system that is connected to an external source, e.g., to a network, in the case of a cyber-physical system or locally operating a physical system. The connectedness of such networked control systems renders them increasingly vulnerable to threats and, in some cases, multiple attacks may occur simultaneously. Protecting an asset may depend on detecting anomalous behavior of individual components caused by cyber-based attacks and distinguishing between such attacks and naturally occurring faults and failures.

Further, because an attack or an anomaly can propagate through the system because of its connectedness, localization and isolation of an attack to prevent further vulnerabilities is also needed. For, example, cyber-physical systems, attack or anomaly detection and isolation at the physical process level may be based on monitoring the process variables such as sensor measurements and actuator commands in a control system.

Existing approaches to protect an industrial control system, such as failure and diagnostics technologies, may not adequately address these threats-especially when multiple, simultaneous attacks or anomalies occur over the network. Moreover, existing approaches do not address the need to localize and isolate an attack or an anomaly on a networked or connected system. It would, therefore, be desirable to protect an industrial asset from cyber threats and other malfunctions in an automatic and accurate manner. Malfunctions, as referred to herein, include any anomalous behavior of one or more monitoring nodes and/or the system as a whole. The malfunction may be the result of a naturally occurred physical event or a cyber incident.

Accordingly, the systems, methods and devices for anomaly detection and forecasting described in the present disclosure are designed to enable early detection of hazard, fault, and salient and stealthy attacks in a fully or partially distributed system. The system described herein monitors a plurality of nodes (each node representing an edge device) connected in the network, and within each node, a plurality of critical sensors, actuators and other components and parameters, to detect and isolate anomalies and generate alarms in the presence of anomalies and/or hazards. The systems, methods and devices disclosed herein also enable anomaly detection and localization for networked systems by utilizing distributed edge computing for cyber-physical security. The systems, methods and devices disclosed herein increase security of an industrial internet of things (IIoT) network using process monitoring. The systems, methods and devices disclosed herein provide a flexible architecture that can be adapted to virtually any network topology.

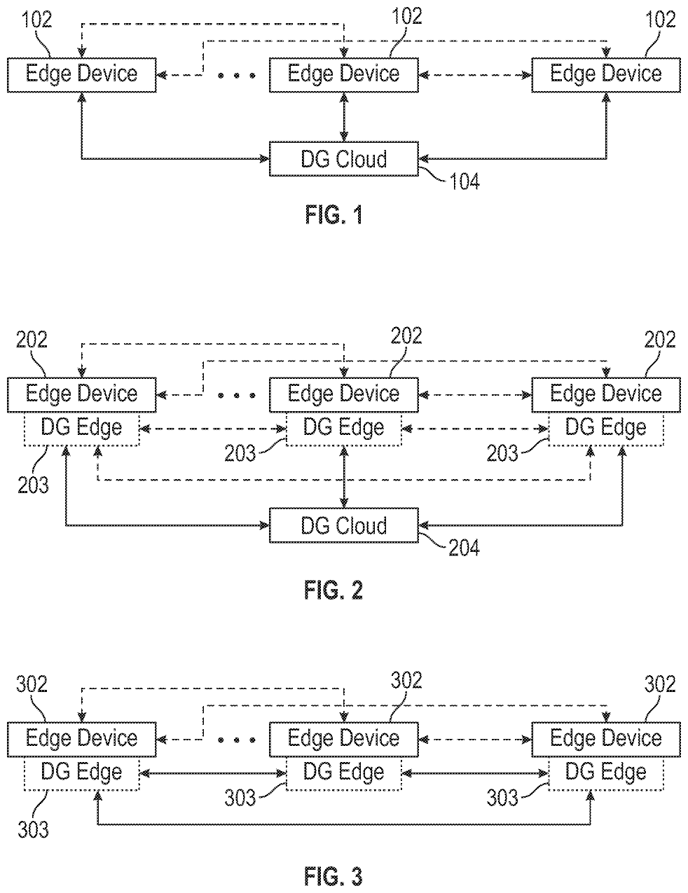

FIG. 1 shows a centralized architecture for attack detection and localization using a single digital ghost agent 104 sitting in the cloud monitoring a collection of edge devices 102. In such architecture, all the computation associated with detection and localization of a threat, attack or fault is centralized at the cloud. In such an architecture, the centralized digital ghost demands high computational power. Consequently, there may be network delays, thus resulting in low detection accuracy in large scale networks.

As used here, the term “digital ghost agent” refers to a monitoring node that monitors a corresponding edge device for anomalies such as, for example, a threat, an attack or a fault. An edge device is, for example, a physical device or asset in a network or industrial network and includes one or more physical and/or software components, which when operational, generate real-time data that may be shared with the corresponding digital ghost agent. In some embodiments, the digital ghost agent includes, for example, a virtual model of the corresponding edge device, the virtual model representing operational, functional and physical characteristics of the corresponding edge device. The digital ghost agent may, thus, monitor the performance of the corresponding edge device for normal or abnormal behavior by comparing the current performance of the corresponding edge device with a modeled performance in real time. The digital ghost agent is also referred to herein as a virtual agent. In some implementations the virtual agent may be a base station or a media access control station in a wireless network.

In some embodiments, the digital ghost agent may include an artificial intelligence model or a machine learning model (also referred to herein as an “AI/ML model”) that can be continuously trained to monitor normal function of its corresponding edge device and consequently detect an anomaly or anomalous behavior in the performance of the corresponding edge device.

In some embodiments, the digital ghost agent may include a machine learning model or an artificial intelligence model that has been trained to detect anomalous behavior of the corresponding edge device to enable detection of an anomaly when it occurs. In some embodiments, the machine learning model or the artificial intelligence model is initially trained on historic normal operational data as well as attack/anomaly data collected from the corresponding edge device (and/or of one or more edge devices of similar type as the corresponding edge device). Further, the machine learning model or the artificial intelligence model is continually updated with the real-time data obtained from and during the operation of the corresponding edge device. Such embodiments may require less computational resource by avoiding the running of a model mimicking the edge device, and instead only detecting abnormal performance. In some embodiments, the digital ghost agent may utilize any one of the various methods for monitoring, detection and/or localization of anomalies disclosed herein.

Non-limiting examples of machine learning models that may be used for monitoring normal operation and/or detecting anomaly or anomalous behavior include supervised learning models such as neural networks, support vector machine, logistic regression, random forest models and decision tree algorithms; unsupervised learning models such as K-means clustering, principal component analysis, hierarchical clustering and semantic clustering; and semi-supervised learning models such as generative adversarial networks. According to some embodiments, a training method may be used for supervised learning to teach decision boundaries. This type of supervised learning may take into account on operator's knowledge about system operation (e.g., the differences between normal and abnormal operation).

In some embodiments, the determination of the probability values that a detected anomaly is a malfunction and/or a failure of one or more monitoring nodes, and/or the probability values that the detected anomaly is an attack and/or a threat may be provided to the AI/ML model. In some embodiments, the AI/ML model may determine the probability values that a detected anomaly is a malfunction and/or a failure of one or more monitoring nodes, and/or the probability values that the detected anomaly is an attack and/or a threat using stochastic models based on the physics of the monitoring nodes. In either instance, the probability values may be used for training the AI/ML model.

In some embodiments, normal and/or anomalous behavior is detected using an artificial intelligence model by, for example, recognizing patterns in feature vectors, that define a behavior space for the behavior of the monitoring nodes (e.g., based on temporal changes in feature vectors), as being normal or anomalous. In some embodiments, the artificial intelligence model may be further trained to recognize patterns in feature vectors that are anomalous because of a fault or malfunction at one or more monitoring nodes and patterns in feature vectors that are anomalous because of a threat or an attack on one or more monitoring nodes and/or a threat or an attack on the system.

In some implementations of the present disclosure, the distribution, transfer and training of the machine learning and/or artificial intelligence models (also referred to herein as the “AI/ML models”) for various applications may be governed by the protocols associated with the network (e.g., a 5G network) underlying the digital ghost agents. For example, the operation logic associated with the AI/ML models may be controlled by an application function which send requests to the network in accordance with the network protocols.

In this context, in some embodiments, the traffic associated with implementation of the AI/ML models, i.e. data or ML model for AI/ML operations in application layer, can be transmitted as specific quality of service (QOS) flow(s) which is/are different from the QoS flows used for common application data (i.e. non-AI/ML related data over the application layer). Thus, the network data analytics function (NWDAF) can collect data and derive analytics information on the QoS flow(s) for transmission of the traffic associated with the AI/ML models, and based on the analytics information the session management function (SMF) may perform traffic routing optimization for the traffic associated with the AI/ML models. Specific examples of such implementations using a 5G network may be found in the 3GPP Technical Report 3GPP TR 23.700-80 v1.10 (2022-10) Release 18, which is incorporated by reference in its entirety.

FIG. 2 shows a partially distributed anomaly detection and/or localization architecture in accordance with an embodiment of the present disclosure. In such an embodiment, a digital ghost agent 203 is associated with each edge device 202 and different digital ghost agents 203 can communicate with a centralized digital ghost agent 204 (e.g., based in the cloud) and optionally to each other.

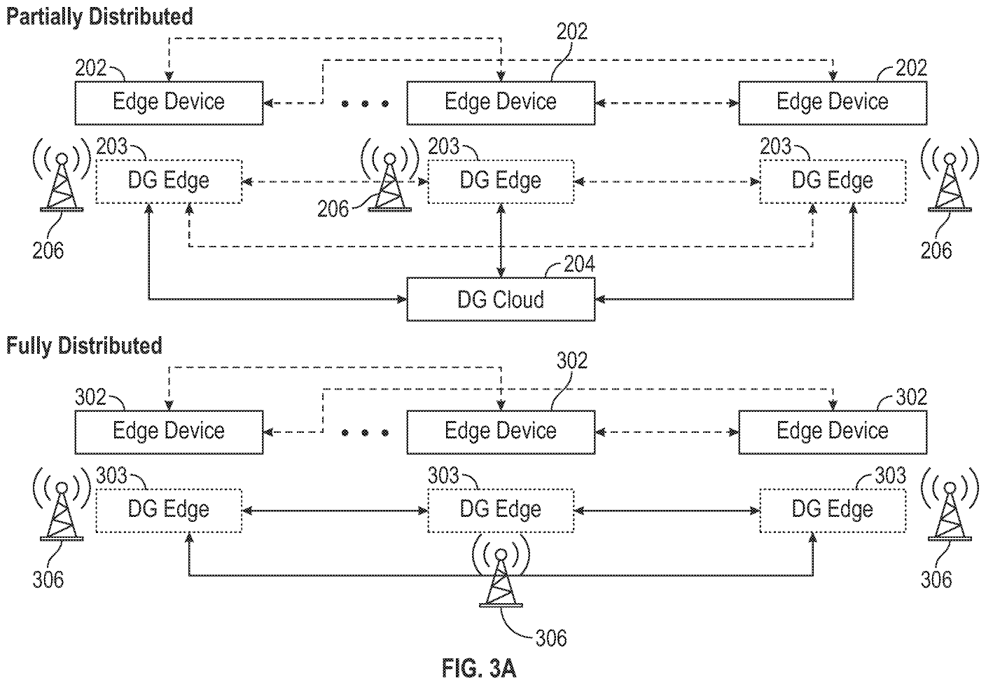

FIG. 3 shows a fully distributed anomaly detection and/or localization architecture in accordance with an embodiment of the present disclosure. In such an embodiment, the centralized digital ghost agent (e.g., a digital ghost cloud agent) is removed, and digital ghost edge agents 303 communicate directly with each other.

In some embodiments, as depicted in FIGS. 2 and 3, the digital ghost agent 203/303 is physically at the corresponding edge device 202/302. In some embodiments, as depicted in FIG. 3A, the digital ghost agent 203/303 for the corresponding edge device 202/302 may be implemented at an access point (or a base station) 206/306 of a network on which the edge devices and/or their respective digital ghost agents communicate with each other. In some embodiments, the digital ghost agent may be associated with more than one edge devices of similar type or functionality. In some embodiments, an access point 206/306 may have implemented thereon multiple digital ghost agents 203/303 each corresponding to a different edge device 202/302. In such embodiments, implementations of digital ghost agents on access points/base stations (i.e., physically distant away from the edge devices) may be based on or utilize multi-access edge computing (MEC) architecture of the 5G network.

In both, the partially and the fully distributed architectures, the topology of the digital ghost network follows the original topology of the IIoT network via which the edge devices are connected. In some embodiments, a subset of a network may have a fully distributed architecture and another subset of the same network may have a partially distributed architecture, thereby mixing and matching of both architectures in different subsets of the network.

In both, the fully and the partially distributed architectures, the digital ghost agents can share data and information with each other to enable global and local decisions regarding current performance, and detection and/or localization of anomalies. For example, the digital ghost agents (and in case of partially distributed architecture, the digital ghost cloud agent) may share information such as their extracted features, anomaly statuses, and anomaly scores.

In some embodiments, the digital ghost agents are connected via a 5G network (or a network based on a 3GPP standard). Thus, each data flow (between digital ghost agents or between a digital ghost agent and the digital ghost cloud) has an associated security metric for its specific path through the 5G network comprised of the individual nodes (e.g., edge devices). The security metric may include link security metrics comprising the path such that an overall security value can be computed for a flow. Further, each standard 5G subcomponent may have at least one interoperable digital ghost agent as part of its standard within the 5G architecture.

The 5G digital ghost agent interoperability flows may be semantic flows where data is comprised of machine learning features and characteristics. The 5G machine learning data features may be unique to the 5G standard and may contain a common set of communication-oriented features included in the 5G standard.

Additionally, the standard 5G time constraints may be characterized for all messages that are exchanged between digital ghost agents. The time constraints include, for example, maximum latency, determinism, and other parameters laid out in the 5G standard. Further, the digital ghost flows (i.e., information exchanged between digital ghost agents or between a digital ghost agent and the digital ghost cloud) may have standard classical security protections such as, for example, authentication. confidence, integrity, and the like.

The digital ghost flows and messages interconnect digital ghost distributed modules. For example, knowledge management, context awareness, cognition management, situational awareness, model-driven engineering, policy management, may all be interconnected by a semantic data bus. In some embodiments, homomorphic processing of digital ghost flows may take place within the 5G network. For example, machine learning data flows may be compared, combined, and redundant data may be discarded.

In addition, utilizing features of the 5G standard enables the distinction between the training and monitoring of digital ghost agents. For example, training requires real-time control loop within the 5G system. On the other hand, monitoring mostly relates to one-way communication (rather than a control loop) from the digital agents to one or more digital ghost learning engines (either at other digital ghost agents or at the central digital ghost, where available). The digital ghost control of 5G standard components may result in two-way real-time operation. In other words, the 5G standard components may be utilized to generated automated reactions.

5G digital ghost agents may be active agents so as to enable code and/or packets to change and/or evolve within the 5G standard. The digital ghost agents may propagate, install and upgrade themselves when and where needed. The use of 5G standard for the digital ghost agents to communicate with each other allows the digital ghost agents to be pre-installed at the edge devices as integral parts of all 5G subsystems. Thus, in some embodiments, each 5G component (e.g., RAN, CU, DU, UE, MEC, core, etc.) may have its own digital ghost components and standardized protocol e.g., as part of a zero-touch management system.

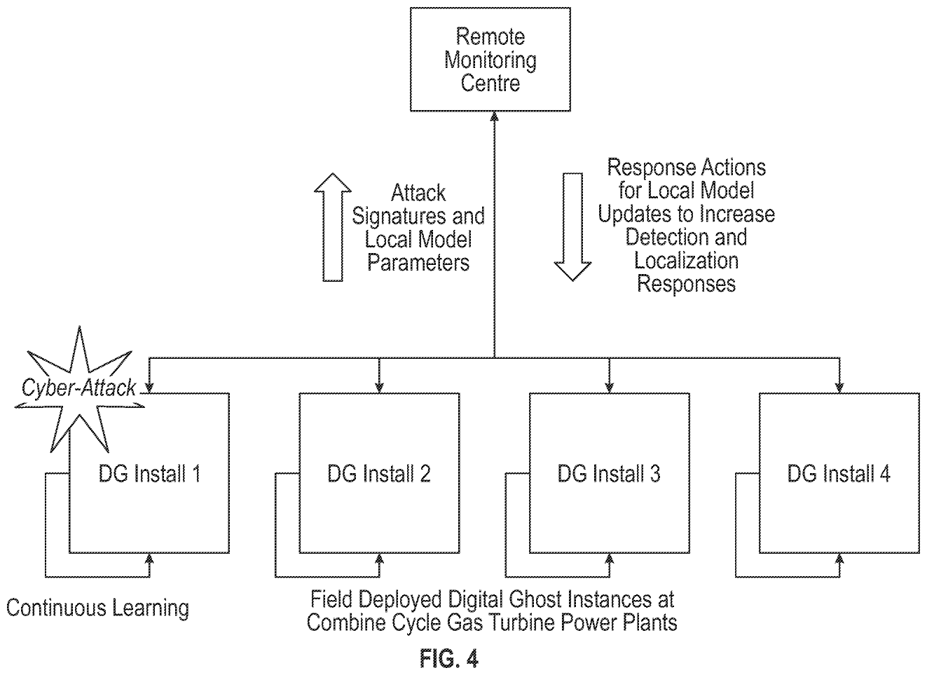

FIG. 4 shows how information relating to performance, monitoring, detection and/or localization may be shared among digital ghost agents in accordance with the embodiments of the present disclosure. In various embodiments, the digital ghost agents (whether in partially or fully distributed architectures shown in FIGS. 2 and 3 respectively) utilize federated learning algorithms to continuously learn and update the underlying machine learning models. The digital ghost agents may also share anomaly information for the online updates through continuous learning. The information may be shared directly with other digital ghost agents or with a digital cloud agent or both, for vetting and routing.

Thus, the proposed distributed and partially distributed architectures can be, for example, leveraged to enable local learning and exchange of attack signatures, while preserving sensitive data about the edge devices' performance or operation.

As an example, local digital ghost agents can be deployed in the field monitoring multiple heavy-duty gas turbines. Each digital ghost agent can perform continuous learning to fine tune its decision manifold to the particular edge device or asset's real time configuration, operational profile, and health status. The learning can be performed locally without the need to transfer timeseries data to a remote center. However, when an anomaly is detected for example, due to a cyber-attack, key signatures present in the attack profile may be securely transported to a remote monitoring center (and/or to other digital ghost agents). In a deployed system, as long as the anomaly detection system is not compromised, these signatures and associated information be sent securely to other remote digital ghost agents, so that the remote digital ghost agents can fine tune their detection and localization algorithms for the particulars of the attack. To ensure the integrity of the anomaly detection system, while the asset is under an attack, a self-certification AI watchdog may be exploited. Such AI watchdog is described in detail elsewhere herein.

In some embodiments, each digital ghost agent may be configured to obtain real-time data from the corresponding edge device (referred to herein as “raw data”), and process the raw data to extract one or more features which are represented in a feature vector. Further, the digital ghost agent may be configured for anomaly detection and/or anomaly localization based on anomaly detection/localization techniques or algorithms implemented on the digital ghost agent. Such anomaly detection/localization techniques or algorithms may utilize the raw data and/or the feature vectors for anomaly detection/localization.

In some embodiments, a digital ghost agent 203/303 (and/or digital cloud 104/204) is configured to detect anomaly in or attack on the corresponding edge device based on one or more systems and techniques described in U.S. application Ser. No. 17/406,205, which is incorporated herein by reference in its entirety. Further, once an anomaly is detected within the system, the digital ghost agent 203/303 (and/or digital cloud 104/204) may be configured to localize the anomaly using methods described in U.S. Pat. No. 10,417,415, which is incorporated herein by reference in its entirety. A detected anomaly may be an attack and the digital ghost agent 203/303 (and/or digital cloud 104/204) may be configured to isolate and/or neutralize such an attack using methods described in U.S. Pat. No. 10,771,495, which is incorporated herein by reference in its entirety.

In some embodiments, the digital ghost agents are configured to communicate or share data related to the corresponding edge devices with other digital ghost agents and/or the digital ghost cloud. The data to be shared may relate to the real-time data obtained from the edge device and the anomaly detection/localization/neutralization data generated at the digital ghost device. For data security and privacy purposes, the digital ghost agents may not share raw data obtained from the edge devices and as such, may only share feature vectors or information associated with the features obtained using the raw data. Further, in some embodiments, any communication between digital ghost agents and between a digital ghost agent and the digital ghost cloud may be secured or encrypted based on one or more secure communication techniques configured at the digital ghost agents and cloud and acceptable to the network. The secure communication techniques may include different cryptographic methods such as, for example, as described in U.S. Pat. No. 8,781,129, which is incorporated herein by reference in its entirety. The secure communication techniques may be based on one or more of secure ledger blockchain-based techniques, quantum-key distribution (QKD)-based techniques, homomorphic cryptographic techniques, etc. The shared information among the agents may be used for model update within each agent using continuous and online learning methods described in detail elsewhere herein.

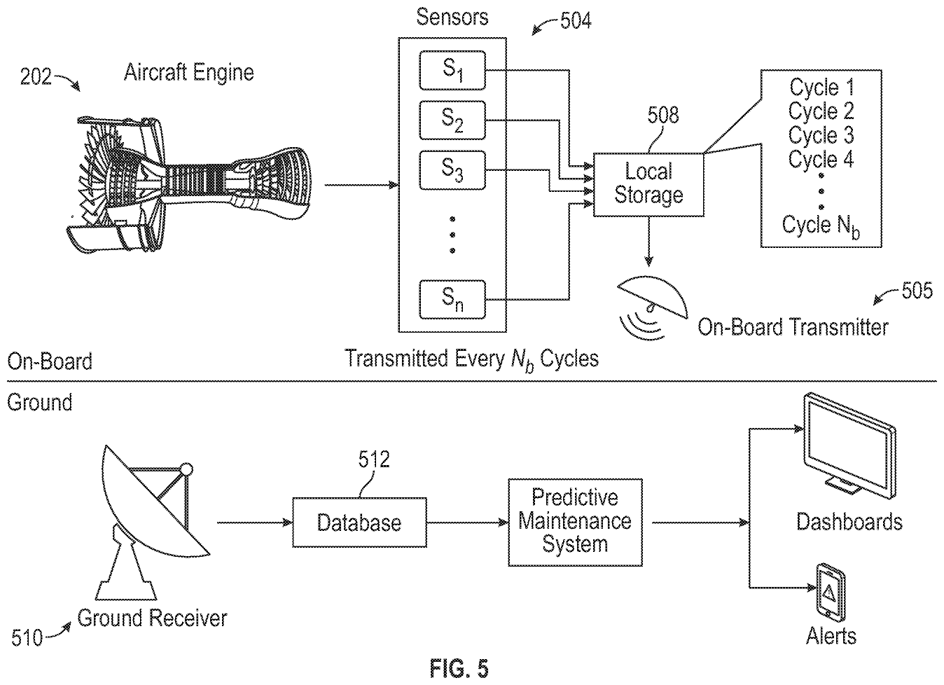

FIG. 5 illustrates an anomaly detection and mitigation system which may be implemented at a digital ghost agent 203/303, in accordance with at least some embodiments of the present disclosure.

As depicted in FIG. 5, the industrial asset (representing an edge device 202/302) includes a plurality of sensors S1, S2, S3. . . . Sn. The industrial asset may also include an on-board transmitter 505 for transmitting data collected by the sensors. In some embodiments, the data collected by each of the sensors is transmitted (after potentially some pre-processing) in real-time, e.g., via a reliable high-speed wireless network such as a 5G network.

In some embodiments, each sensor may be coupled to a local storage 508 to store the data collected by the sensor. In some embodiments, a subset of the plurality of sensors may be coupled to a local storage (instead of each sensor having a local storage). In some embodiments, the data collected by the sensors is stored at the local storage and transmitted (after potentially some pre-processing) periodically, e.g., every N cycles, N being a natural number. In some embodiments, the local storage is coupled to a transmitter for transmitting the stored data to a central database 512, e.g., via a receiver 510 coupled to the central database.

As depicted in FIG. 5, the central database 512 is on the ground while the local storage 508 and sensors 504 are on the aircraft and associated with the aircraft engine 202. Thus, the sensors 504 associated with the aircraft engine 202 generate data and periodically (or in real-time) transmit the data to a local storage 508, which is then consolidated and transmitted, e.g., via a transmitter 505 on-board the aircraft, to a central database 512 via the ground receiver 510 through a high speed and reliable wireless link (such as a 5G network) for further processing. The data may be transferred in real-time, streaming with the same framerate as the collection sampling time, or with some buffering using the local storage (e.g. per flight cycle).

The data collected at the central database is processed to perform operations such as, for example, anomaly/fault detection and isolation, predictive situation awareness, prognostics and health monitoring, safety monitoring, etc., and generate corresponding analytics. The produced analytics (or a subset of them) may be communicated back to the industrial asset (e.g. the aircraft engine depicted in FIG. 5) for alarm and warning generation, and potential operation and control optimizations. It may also generate early warning of incipient events to the operators.

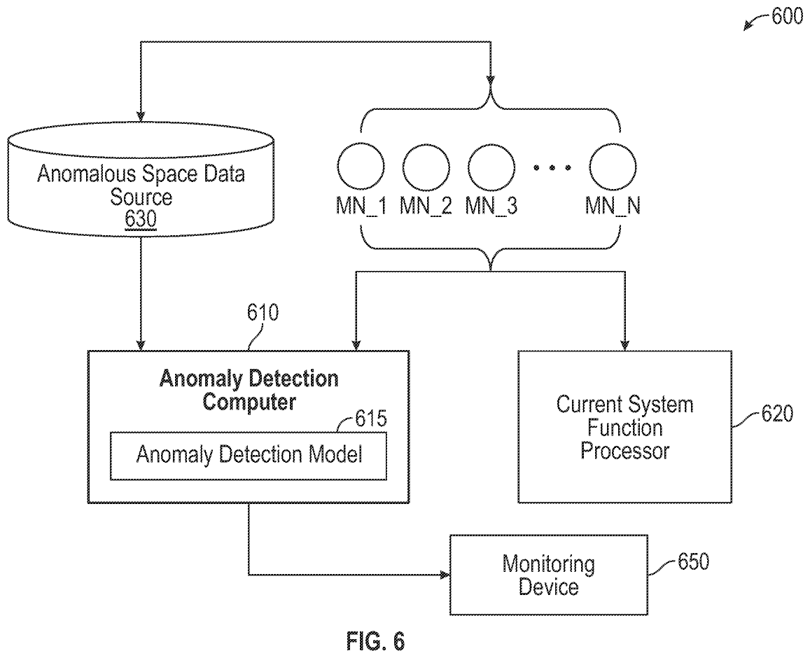

FIG. 6 illustrates an anomaly detection system 600 in accordance with at least some embodiments of the present disclosure The anomaly detection system includes an anomaly detection computer 610, a current system function processor 620, an anomalous space data source 630 and a monitoring device 650. The anomalous space data source 630, in some embodiments, includes a central database (not explicitly shown), e.g., such as one depicted in FIG. 2, for collecting data from a plurality of sensors (also referred to herein as monitoring nodes) MN_1, MN_2, MN_3, . . . . MN_N.

As used herein, devices, including those associated with the system 600 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The anomaly detection computer 610 processes data from the central database using, e.g., an anomaly detection model 615, to generate an anomalous feature vector for each of the plurality of monitoring nodes. The anomalous feature vectors together define an anomalous space which is stored in the anomalous space data source 630.

The anomaly detection computer 610 may store information into and/or retrieve information from various data stores, such as the anomalous space data source 630 or any of the data sources included within the anomalous space data source such as, a normal space data source (not explicitly shown) for storing sets of normal feature vectors for each of the plurality of monitoring nodes. The various data sources may be locally stored or reside remote from the anomaly detection computer 610. Although a single anomaly detection computer 610 is shown in FIG. 6, any number of such devices may be included. Moreover, various devices described herein might be combined according to embodiments of the present disclosure. For example, in some embodiments, the anomaly detection computer 610 and data sources 630 might comprise a single apparatus. The anomaly detection computer 610 functions may be performed by a constellation of networked apparatuses, in a distributed processing or cloud-based architecture.

A user may access the system 600 via one of the monitoring devices 650 (e.g., a Personal Computer (“PC”), tablet, or smartphone) to view information about and/or manage anomaly detection information in accordance with any of the embodiments described herein. In some cases, an interactive graphical display interface may let a user define and/or adjust certain parameters (e.g., threat detection trigger levels) and/or provide or receive automatically generated recommendations or results from the anomaly detection computer 610.

Thus, the system disclosed herein receives time-series data from a collection of monitoring nodes over the IoT network devices and assets (sensor/actuators/controller nodes), and extracts features from the time series data for each monitoring node. The term “feature” may refer to, for example, mathematical characterizations of data Examples of features as applied to data might include the maximum and minimum, mean, standard deviation, variance, settling time, Fast Fourier Transform (“FFT”) spectral components, linear and non-linear principal components, independent components, sparse coding, deep learning, etc. as outlined in U.S. Pat. No. 9,998,487, which is incorporated herein by reference in its entirety.

The type and number of features for each monitoring node, might be optimized using domain-knowledge, feature engineering, or receiver operating characteristic (ROC) statistics. The features are calculated over a sliding window of the signal time series. The length of the window and the duration of slide are determined from domain knowledge and inspection of the data or using batch processing. The features are computed at the local (associated with each particular monitoring node) and global (associated with the whole asset or a part of the network) levels. The time-domain values of the nodes or their extracted features may be normalized for better numerical conditioning.

Referring back to FIG. 6, the anomaly detection model 615 represents anomalous operation of one or more monitoring nodes and/or anomalous operation of the industrial asset as a whole. It must be noted that the term “anomalous operation” or “anomalous functioning” includes behavior of a monitoring node or the industrial asset as a whole that is different from what would typically be considered as normal or expected operational behavior and may be caused either by natural malfunctioning or failure or because of an ongoing or an impending attack or threat on one or more monitoring nodes and/or the industrial asset as a whole.

In some embodiments, the anomaly detection model 615 may include a plurality of sub-models, each representing anomalous operation of one or more monitoring nodes and/or the industrial asset over a different time scale. Thus, for example, the anomaly detection model 615 may include a sub-model representing anomalous operation over several seconds, a sub-model representing anomalous operation over several minutes or hours, and a sub-model representing anomalous operation over several days or weeks.

In some embodiments, the anomaly detection model includes at least one sub-model based on historical operation of the plurality of monitoring nodes and the industrial asset. In some embodiments, the at least one sub-model based on historical operation is based on historically normal operation of the plurality of monitoring nodes and/or the industrial asset. In such embodiments, the system may further include a normal space data source (not explicitly shown) for storing sets of normal feature vectors for each of the plurality of monitoring nodes generated by the at least one sub-model based on historically normal operation of the plurality monitoring nodes and the industrial asset.

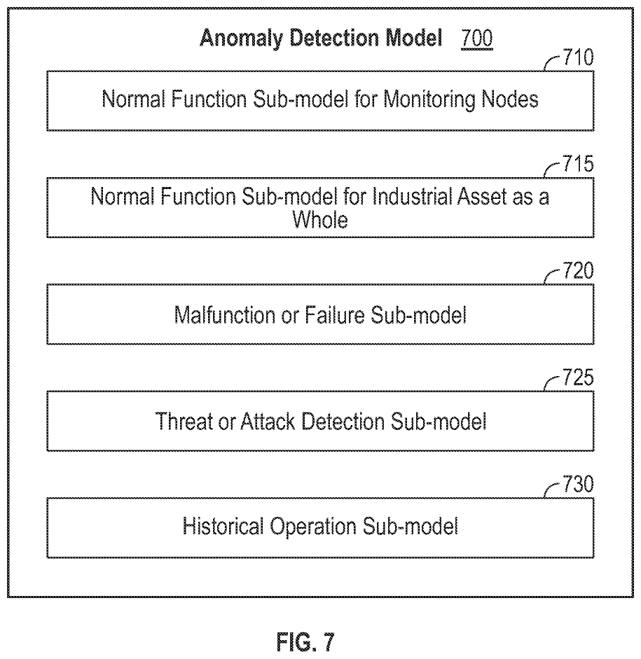

FIG. 7 illustrates an example of the anomaly detection model in accordance with at least some embodiments of the present disclosure. The anomaly detection model 700 may, thus, include a normal function sub-model for the plurality of monitoring nodes 710, a normal function sub-model for the industrial asset as a whole 715, a malfunction or failure detection sub-model 720, a threat or attack detection sub-model 725, and a historical operation sub-model 730.

In some embodiments, implementing the anomaly detection model comprises a method including obtaining an input dataset from a plurality of nodes (e.g., the nodes, such as sensors, actuators, or controller parameters; the nodes may be physically co-located or connected through a wired or wireless network (in the context of 5G/IoT)) of industrial assets. The method may also include predicting a fault node in the plurality of nodes by inputting the input dataset to a one-class classifier (e.g., using a reconstruction model).

The one-class classifier is trained on normal operation data (e.g., historical field data or simulation data) obtained during normal operations (e.g., no cyber-attacks) of the industrial assets. In some embodiments, the method may further include computing a confidence level (e.g., using the confidence predictor module) of malfunction detection for the input dataset using the one-class classifier. A decision threshold may be adjusted based on the confidence level computed by the confidence predictor for categorizing the input dataset as normal or including a malfunction. The malfunction is detected in the plurality of nodes of the industrial assets based on the predicted fault node and the adjusted decision threshold.

In some embodiments, the method may further include computing reconstruction residuals (e.g., using the reconstruction model) for the input dataset such that the residual is low if the input dataset resembles the normal operation data, and high if the input dataset does not resemble the historical field data or simulation data. Detecting malfunction in the plurality of nodes includes comparing the decision thresholds to the reconstruction residuals to determine if a datapoint in the input dataset is normal or anomalous.

In some embodiments, the one-class classifier is a reconstruction model (e.g., a deep autoencoder, a GAN, or a combination of PCA-inverse PCA, depending on the number of nodes) configured to reconstruct nodes of the industrial assets from the input dataset, using (i) a compression map that compresses the input dataset to a feature space, and (ii) a generative map that reconstructs the nodes from latent features of the feature space.

In some embodiments, the method may further include: designating boundary conditions (e.g., ambient conditions) and/or hardened sensors to compute location of the input dataset with respect to a training dataset used to train the one-class classifier, for computing the confidence level of malfunction detection using the one-class classifier. In absence of that, all attacks would likely be classified as a sparse region or extrapolation from training set. If most of the attacks are accompanied by lower confidence predictions, they would be evaluated against relaxed thresholds, leading to a lower TPR. As described above, hardened sensors are physically made secure by using additional redundant hardware. The probability that those sensors are attacked is very low. Some embodiments determine the confidence metric so as to avoid this undesirable scenario.

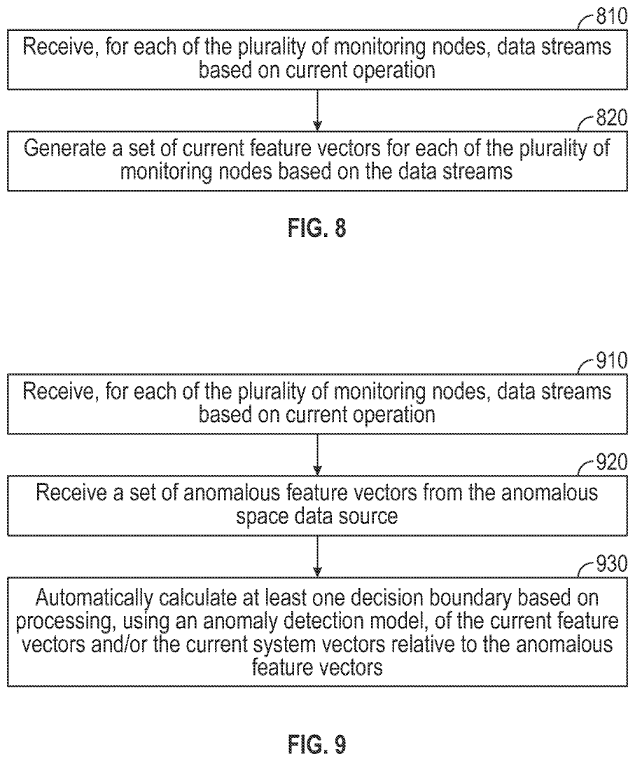

In some embodiments, the anomaly detection model 615 is generated and/or refined by the anomaly detection computer 610. FIG. 8 illustrates a method of generating current system function parameters that may be performed by the current system function processor 620 described herein, such as the anomaly detection computer 610.

The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At 810, the system may retrieve, for each of a plurality of monitoring nodes, a data stream of current monitoring node values that represent current operation of the industrial asset control system. At 820, based on the data streams, a set of current feature vectors may be generated.

FIG. 9 illustrates a method of generating a decision boundary that may be performed by an anomaly detection computer, in accordance with at least some embodiments of the present disclosure. The series of normal (i.e., non-anomalous) and/or anomalous values might be obtained, for example, by running Design of Experiments (“DoE”) on an industrial control system associated with a power turbine, a jet engine, a locomotive, an autonomous vehicle, etc.

At 910, the system may retrieve, for each of a plurality of monitoring nodes, a data stream of current monitoring node values that represent current operation of the industrial asset control system. At 920, the system may retrieve a set of anomalous feature vectors for each of the plurality of monitoring nodes from the anomalous space data source.

At 930, a decision boundary may be automatically calculated and output, by processing, using the anomaly detection model, the current feature vectors relative to the anomalous feature vectors. According to some embodiments, the decision boundary might be associated with a line, a hyperplane, a non-linear boundary separating normal space from threatened space, and/or a plurality of decision boundaries. Moreover, a decision boundary might comprise a multi-class decision boundary separating normal space and anomalous space (including, e.g., a degraded operation space). In addition, note that the anomaly detection model might be associated with the decision boundary, feature mapping functions, and/or feature parameters.

The decision boundary can then be used to detect cyber-attacks. For example, in some embodiments, the result of processing by the anomaly detection model may be processed to transmit a threat alert signal based on the set of current feature vectors and a decision boundary when appropriate (e.g., when component failure is detected, or a cyber-attack is detected) According to some embodiments, one or more response actions may be performed when a threat alert signal is transmitted. For example, the system might automatically shut down all or a portion of the industrial asset control system (e.g., to let the detected potential cyber-attack be further investigated). As other examples, one or more parameters might be automatically modified, a software application might be automatically triggered to capture data and/or isolate possible causes, etc.

Some embodiments described herein may take advantage of the physics of a control system by learning a priori from tuned high fidelity equipment models and/or actual “on the job” data to detect single or multiple simultaneous adversarial threats to the system. Moreover, according to some embodiments, all monitoring node data may be converted to features using advanced feature-based methods, and the real-time operation of the control system may be monitoring in substantially real-time. Abnormalities may be detected by classifying the monitored data as being “normal” or disrupted (or degraded). Disrupted data may be further classified as being based on a component malfunction and/or failure, or based on a threat or attack. Thus, the decision boundary may be based on a probability that a detected anomaly is a malfunction and/or a failure of one or more monitoring nodes, and/or a probability that the detected anomaly is an attack and/or a threat. This decision boundary may be constructed using dynamic models and may help enable early detection of vulnerabilities (and potentially avert catastrophic failures) allowing an operator to restore the control system to normal operation in a timely fashion.

Note that an appropriate set of multi-dimensional feature vectors, which may be extracted automatically (e.g., via an algorithm) and/or be manually input, might comprise a good predictor of measured data in a low dimensional vector space. According to some embodiments, appropriate decision boundaries may be constructed in a multi-dimensional space using a data set which is obtained via scientific principles associated with DoE techniques. Moreover, multiple algorithmic methods (e.g., support vector machines or machine learning techniques) may be used to generate decision boundaries. Since boundaries may be driven by measured data (or data generated from high fidelity models), defined boundary margins may help to create a threat zone in a multi-dimensional feature space. Moreover, the margins may be dynamic in nature and adapted based on a transient or a steady state model of the equipment and/or be obtained while operating the system as in self-learning systems from incoming data stream. According to some embodiments, a training method may be used for supervised learning to teach decision boundaries. This type of supervised learning may take into account on operator's knowledge about system operation (e.g., the differences between normal and abnormal operation).

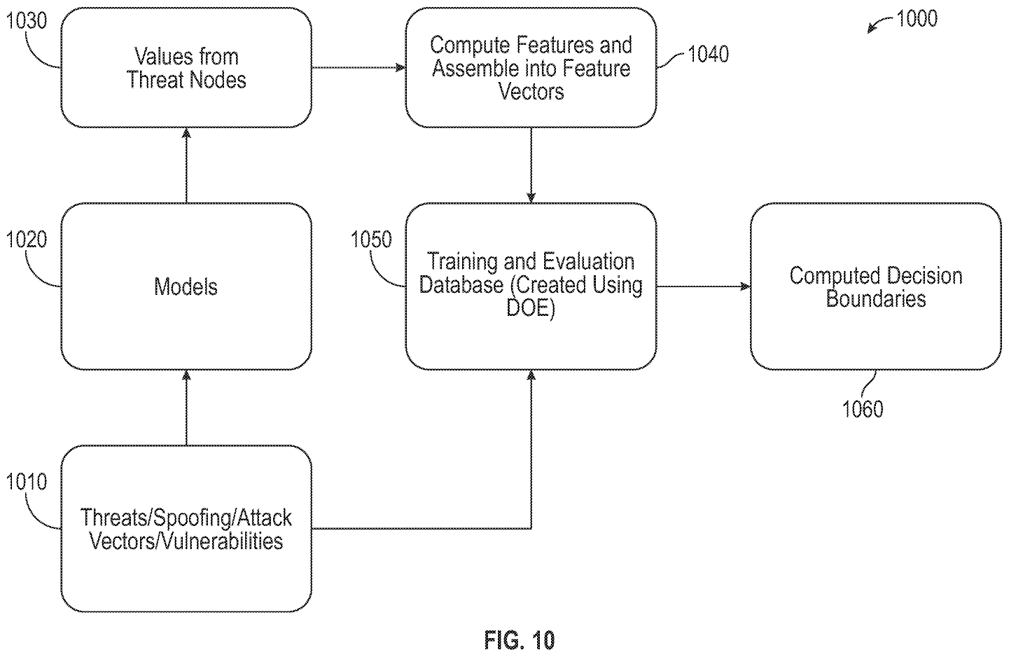

FIG. 10 illustrates an off-line boundary creation process 1000 in accordance with some embodiments. Information about threats, spoofing, attack vectors, vulnerabilities, etc. 1010 may be provided to models 1020 and/or a training and evaluation database 1050 created using DoE techniques. The models 1020 may, for example, simulate data 1030 from threat nodes (i.e., subset of monitoring nodes that may be considered vulnerable to threats and/or attacks) to be used to compute features that are assembled into a feature vector 1040 to be stored in the training and evaluation database 1050. The data in the training and evaluation database 1050 may then be used to compute decision boundaries 1060 to distinguish between normal operation and threatened operation. According to some embodiments, the process 1000 may include a prioritization of threat nodes and anticipated threat vectors (i.e., anomalous feature vectors that may be classified as being the result of a threat or an attack based on e.g., analysis of historical operation) to form one or more data sets to develop decision boundaries. Threat vectors are abnormal values at critical inputs where malicious attacks can be created at the domain level that will make the system go into threatened/abnormal space (i.e., a subset of the anomalous space formed based on threat vectors). In addition, the models 1020 may comprise high fidelity models that can be used to create a data set (e.g., a set that describes threat space as “levels of threat conditions in the system versus quantities from the threat nodes”).

The data 1030 from the threat nodes might be, for example, quantities that are captured for a length of from a period of time (e.g., ranging from several seconds to several hours) from sensor nodes, actuator nodes, and/or controller nodes (and a similar data set may be obtained for “levels of normal operating conditions in the system versus quantities from the threat nodes”). This process will result in data sets for “threat space” and “normal space.” The quantities captured over the period of time may be used to compute features 1040 using feature engineering to create feature vectors. These feature vectors can then be used to obtain a decision boundary that separates the data sets for threat space and normal space (used to detect an anomaly such as a cyber-attack).

Since attacks might be multi-prong (e.g., multiple attacks might happen at once), DoE (design of experiments) methods may be designed to capture the attack space (e.g., using full factorial, Taguchi screening, central composite, and/or Box-Behnken). When models are not available, these DoE methods can also be used to collect data from real-world asset control system. Experiments may run, for example, using different combinations of simultaneous attacks. Similar experiments may be run to create a data set for the normal operating space. According to some embodiments, the system may detect “degraded” or faulty operation as opposed to a threat or attack. Such decisions may require the use of a data set for a degraded and/or faulty operating space.

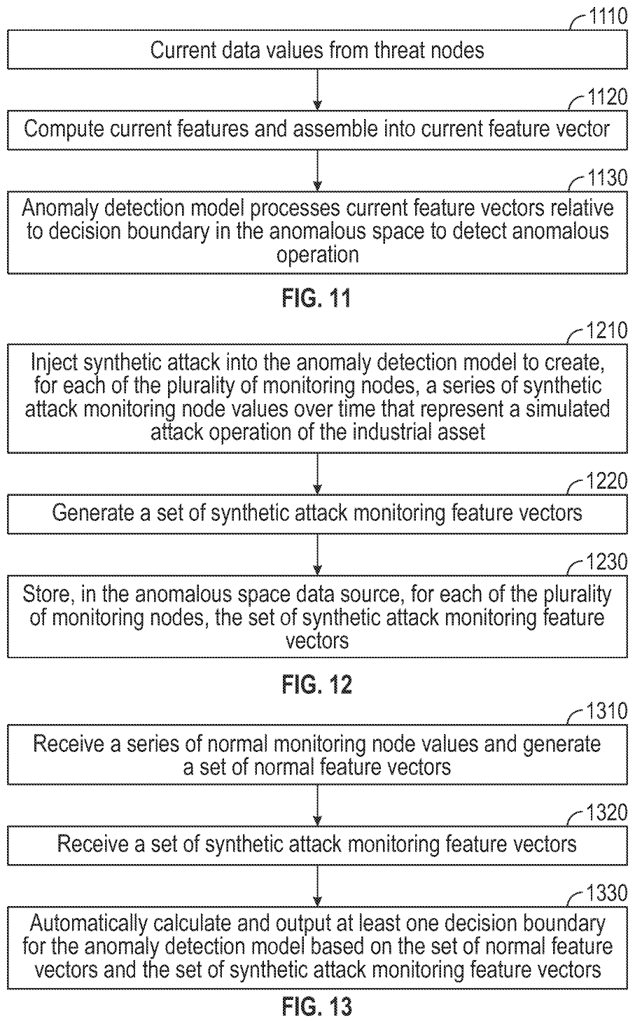

FIG. 11 illustrates a real-time process to protect an industrial asset control system according to some embodiments. At 1110, current data from threat nodes may be gathered (e.g., in batches of from several seconds). At 1120, the system may compute features and form feature vectors. For example, the system might use weights from a principal component analysis as features. At 1130, an anomaly detect model may process the current features vectors relative to the decision boundary in the anomalous space to detect anomalous operation. According to some embodiments, threat node data from models (or from real systems) may be expressed in terms of features since features are a high level representation of domain knowledge and can be intuitively explained. Moreover, embodiments may handle multiple features represented as vectors and interactions between multiple sensed quantities might be expressed in terms of “interaction features.”

Note that many different types of features may be utilized in accordance with any of the embodiments described herein, including principal components (weights constructed with natural basis sets) and statistical features (e.g., mean, variance, skewness, kurtosis, maximum, minimum values of time series signals, location of maximum and minimum values, independent components, etc.). Other examples include deep learning features (e.g., generated by mining experimental and/or historical data sets) and frequency domain features (e.g., associated with coefficients of Fourier or wavelet transforms). Embodiments may also be associated with time series analysis features, such as cross-correlations, auto-correlations, orders of the autoregressive, moving average model, parameters of the model, derivatives and integrals of signals, rise time, settling time, neural networks, etc. Still other examples include logical features (with semantic abstractions such as “yes” and “no”), geographic/position locations, and interaction features (mathematical combinations of signals from multiple threat nodes and specific locations). Embodiments may incorporate any number of features, with more features allowing the approach to become more accurate as the system learns more about the physical process and threat. According to some embodiments, dissimilar values from threat nodes may be normalized to unit-less space, which may allow for a simple way to compare outputs and strength of outputs.

Since some connected assets might be very complex or have too many variants, data-driven digital twins may be utilized for to generate normal/abnormal training datasets as described in U.S. Pat. No. 10,671,060, which is incorporated herein by reference in its entirety.

Furthermore, if any domain-knowledge is available (e.g. from physics, biology, etc.), it can be combined into the digital twin as a hybrid model. The system may comprise of off-line (training) and on-line (operation) modules. During the off-line training, the monitoring node data sets are used for feature engineering and decision boundary generation. The online module is run in real-time to compare the node measurements (converted into the feature space) against the decision boundary and provide system status (normal, abnormal).

In some embodiments, the anomaly detection model may trained based on a set of simulated attacks on the system. The simulation may be performed by injecting a synthetic attack on the system. FIG. 12 is a synthetic attack injection method in accordance with some embodiments. At 1210, at least one synthetic attack may be injected into the anomaly detection model to create, for each of a plurality of monitoring nodes, a series of synthetic attack monitoring node values over time that represent simulated attacked operation of the industrial asset. At 1220, a set of synthetic attack monitoring feature vectors may be generated based on processing of the synthetic attack monitoring node values using the anomaly detection model. At 1230, the system may store, for each of the plurality of monitoring nodes, the set of synthetic attack monitoring feature vectors.

FIG. 13 illustrates a model creation method that might be performed by some or all of the elements of the system described herein. At 1310, the system may retrieve, for each of a plurality of monitoring nodes, a series of normal values over time that represent normal operation of the industrial asset and a set of normal feature vectors may be generated. At 1320 the system may retrieve, for each of the plurality of monitoring nodes, a set of synthetic attack monitoring feature vectors. At 1330, a decision boundary may be automatically calculated and output for the anomaly detection model based on the sets of normal feature vectors, the synthetic attack monitoring feature vectors, and fault feature vectors. According to some embodiments, the decision boundary might be associated with a line, a hyperplane, a non-linear boundary separating normal space from attacked space, and/or a plurality of decision boundaries.

Thus, by training the anomaly detection model using various synthetic attack scenarios, the system disclosed herein can be provided with the capability to detect incipient events. The predicted detection models can run in predictive mode. Some examples of the anomaly forecasting methods that can be used with the system disclosed herein are described in U.S. Pat. No. 10,826,932, which is incorporated herein by reference in its entirety.

Consequently, the system described herein provides for anomaly forecasting in cyber-physical systems connected through IoT (e.g. over a 5G network) for security-oriented cyber-attack detection, localization and early warning. The system and methods disclosed herein are based on forecasting the outputs of cyber-physical system monitoring nodes, using feature-driven dynamic models (e.g., the anomaly detection model described herein) in various different timescales such as, for example, short-term (seconds ahead), mid-term (minutes ahead) and long term (hours to days ahead). The forecasted outputs can be passed to the global and localized attack detection methods to predict upcoming anomalies and generate early warning at different time scales. The early warning may be informed to the system operator and may also be used for early engagement of the automatic attack accommodation remedies.

The system described herein can function using the same sampling rate as the network bandwidth, enabling rapid detection and prediction of anomalous operation. Thus, advantageously, the system can work both deterministic and stochastic data flows and also multi-rate data. As part of the data pre-processing, in some embodiments, the system can synchronizes the data collected from the monitoring node (received with potentially different time-delays) using the last available data from each node and down samples higher rate data to a uniform comment sampling time.

In addition, the system connectivity may potentially also connect to the safety and supervision mechanisms in the network (e.g. a factory process to shut down the hazard). For example, once an electrical incident is detected, the power of the machine may be turned off automatically, or in a welding incident, the welding gun may discontinue, etc. to avoid further injury to the people adjacent to the machine or others.

In some embodiments, all data communication between various components of the system may be performed over encrypted channels.

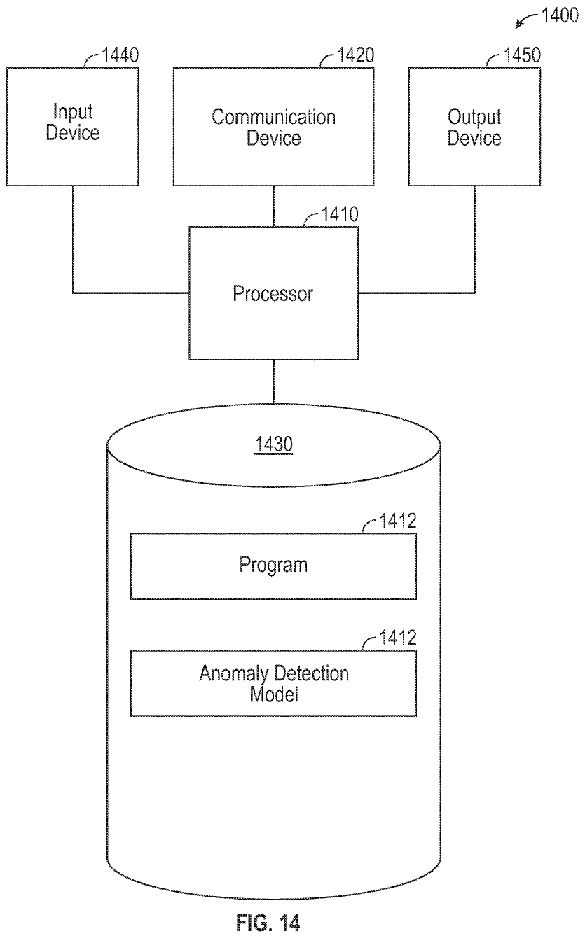

The embodiments described herein may be implemented using any number of different hardware configurations. For example, FIG. 14 is a block diagram of an industrial asset control system protection platform 1400 that may be, for example, associated with the system 100 of FIG. 1. The industrial asset control system protection platform 1400 comprises a processor 1410, such as one or more commercially available Central Processing Units (“CPUs”) in the form of one-chip microprocessors, coupled to a communication device 1420 configured to communicate via a communication network (not shown in FIG. 14). The communication device 1420 may be used to communicate, for example, with one or more remote monitoring nodes, user platforms, digital twins, etc. The industrial asset control system protection platform 1400 further includes an input device 1440 (e.g., a computer mouse and/or keyboard to input adaptive and/or predictive modeling information) and/an output device 1450 (e.g., a computer monitor to render a display, provide alerts, transmit recommendations, and/or create reports). According to some embodiments, a mobile device, monitoring physical system, and/or PC may be used to exchange information with the industrial asset control system protection platform 1400.

The processor 1410 also communicates with a storage device 1430. The storage device 1430 may comprise any appropriate information storage device, including combinations of magnetic storage devices (e.g., a hard disk drive), optical storage devices, mobile telephones, and/or semiconductor memory devices. The storage device 1430 stores a program 1412 and/or an anomaly detection model 1414 for controlling the processor 1410. The processor 1410 performs instructions of the programs 1412, 1414, and thereby operates in accordance with any of the embodiments described herein. For example, the processor 1410 may access a normal space data source that stores, for each of a plurality of threat nodes, a series of normal threat node values that represent normal operation of an industrial asset control system. The processor 1410 may also access an anomalous space data source that stores a series of threatened monitoring node values. The processor 1410 may generate sets of normal and anomalous feature vectors and calculate and output a decision boundary for an anomaly detection model based on the normal and anomalous feature vectors. The plurality of monitoring nodes may then generate a series of current monitoring node values that represent a current operation of the asset control system. The processor 1410 may receive the series of current values, generate a set of current feature vectors, execute the anomaly detection model, and transmit a threat alert signal based on the current feature vectors and the decision boundary.

The programs 1412, 1414 may be stored in a compressed, uncompiled and/or encrypted format. The programs 1412, 1414 may furthermore include other program elements, such as an operating system, clipboard application, a database management system, and/or device drivers used by the processor 1410 to interface with peripheral devices.

As used herein, information may be “received” by or “transmitted” to, for example: (i) the industrial asset control system protection platform 1400 from another device; or (ii) a software application or module within the industrial asset control system protection platform 1400 from another software application, module, or any other source.

In some embodiments (such as the one shown in FIG. 14), the storage device 1430 further stores an anomalous space data source. Note that the database described herein is only one example, and additional and/or different information may be stored therein. Moreover, various databases might be split or combined in accordance with any of the embodiments described herein.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

In various embodiments, the communication networks may be implemented using 5G wireless technology, which includes standards for cyber-physical systems security, vertical control applications and Internet of Things (IoT). For example, the 3GPP TR 22.832 V17.10 (2019-12) (cyber-physical control applications), sections 5.5.6 and 5.5.6 detail standards relating to expected network actions when detecting malicious or unexpected communications. Similarly, 3GPP TS 22.104 (2020-09) (cyber-physical control applications), section A.4.4 details standards relating to distributed automated switching for isolation and service restoration. Likewise, 3GPP TS 33.501 V16.1.0 (2019-12) (5G security), section 5.3.3 details standards relating to integrity protection, detection/isolation of malicious EUs. Each of these documents are incorporated herein by reference in their entirety.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. The described functionality may be implemented in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure described herein.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The term automatic, as used herein, may include performance by a computer or machine without user intervention; for example, by instructions responsive to a predicate action by the computer or machine or other initiation mechanism. The word “example” is used herein to mean “serving as an example or illustration.” Any aspect or design described herein as “example” is not necessarily to be construed as preferred or advantageous over other aspects or designs.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

What is claimed is:

1. A system to protect an industrial asset comprising:
a plurality of monitoring nodes each generating a data stream of current monitoring node values in time-domain; and
a virtual agent associated with each of the plurality of monitoring nodes, the virtual agent being configured to detect anomalous performance of the corresponding monitoring node and configured to communicate with one or more other virtual agents via a network.

2. The system of claim 1, wherein the virtual agent is configured to detect and/or localize anomalous behavior via a machine learning model.

3. The system of claim 2, wherein the virtual agent is configured to continuously learn and update the machine learning model using a federated learning algorithm.

4. The system of claim 1, wherein the virtual agent is implemented at the physical location of a corresponding monitoring node.

5. The system of claim 4, wherein the virtual agent is configured to implement a machine learning model locally, without transferring timeseries data associated with a corresponding monitoring node, to detect anomalous performance of the corresponding monitoring node.

6. The system of claim 5, wherein the virtual agent is further configured to determine, upon detection of an anomaly in performance of the corresponding monitoring node, anomaly signatures relating to the anomaly in performance, and securely transmit the anomaly signatures to a remote monitoring center and/or one or more virtual agents associated with other of the plurality of monitoring nodes.

7. The system of claim 1, wherein the virtual agent is configured to detect anomalous performance of a corresponding monitoring node based on an anomaly detection model, the anomaly detection model including at least one sub-model based on historical operation of the plurality of monitoring nodes.

8. The system of claim 7, wherein the anomaly detection model is configured to predict a fault node among the plurality of monitoring nodes using a one-class classifier model trained on a normal operation data obtained during normal operation of the system.

9. The system of claim 8, wherein the anomaly detection model is further configured to compute a confidence level of malfunction detected in the predicted fault node using the one-class classifier.

10. The system of claim 8, wherein the anomaly detection model is further configured to compute reconstruction residuals for an input dataset obtained from the plurality of nodes such that the residual is low if the input dataset resembles the normal operation data, and high if the input dataset does not resemble the historical field data or simulation data.

11. The system of claim 10, wherein the anomaly detection model is further configured to compare decision thresholds to the reconstruction residuals to determine if a datapoint in the input dataset is normal or abnormal.

12. The system of claim 8, wherein the anomaly detection model is further configured to designate boundary conditions or hardened sensors to compute location of the input dataset with respect to a training dataset used to train the one-class classifier, for computing the confidence level of malfunction detection using the one-class classifier.

13. The system of claim 7, wherein the anomaly detection model is configured to generate a decision boundary based on normal and anomalous values of datapoints obtained from the plurality monitoring nodes.

14. The system of claim 13, wherein the normal and anomalous values are obtained by running a design of experiments (DoE) method.

15. The system of claim 13, wherein the anomaly detection model is further configured to automatically calculate a decision boundary and output, by processing current feature vectors relative to anomalous feature vectors.

16. The system of claim 1, wherein the virtual agent is configured to transmit a threat alert signal upon detection of an anomaly in the performance of a corresponding monitoring node.

17. The system of claim 1, wherein the virtual agent is implemented at an access point via which the corresponding monitoring node is connected to the network.

18. The system of claim 1, wherein data generated by the virtual agents is communicated at a remote monitoring center implementing a program to monitor, detect, localize, neutralize and/or isolate an attack on one or more of the plurality of the monitoring nodes and/or the industrial asset.

19. The system of any of the preceding claims, wherein the network is based on a 3GPP standard.

20. The system of any of the preceding claims, wherein the industrial asset is associated with at least one of: (i) a turbine, (ii) a gas turbine, (iii) a wind turbine, (iv) an engine, (v) a jet engine, (vi) a locomotive engine, (vii) a refinery, (viii) a power grid, (ix) an autonomous vehicle, (x) a telecommunication network, and (xi) an internet of things (IoT).

21. The system of any of the preceding claims, wherein the virtual agent is configured to implement an anomaly detection model trained using a set of simulated attacks on the system.

22. The system of claim 21, wherein a simulated attack on the system comprises, for each of the plurality of monitoring nodes:
creating a series of synthetic attack monitoring node values over time that represent a simulated attacked operation of the system,
generating a set of synthetic attack monitoring feature vectors may be generated based on processing the synthetic attack monitoring node values using the anomaly detection model, and
storing a set of synthetic attack monitoring node feature vectors.

23. The system of claim 1, wherein the industrial asset is a network node, and the network is a 5G network.
